(19) United States
(12) Patent Application Publication
(10) Pub. No.: US 2026/0347542 A1
(43) Pub. Date: Nov. 5, 2026

(54) SELF-HEALING POLYTHIOURETHANE POLYMERIZABLE COMPOSITION, SELF-HEALING POLYTHIOURETHANE PRODUCED THEREFROM, AND SELF-HEALING OPTICAL MATERIAL PRODUCED USING SAME

(71) Applicant: KOREA RESEARCH INSTITUTE OF CHEMICAL TECHNOLOGY, Daejeon (KR)

(72) Inventors: Jin Chul KIM, Daejeon (KR); Ji-Eun JEONG, Daejeon (KR); Young Il PARK, Daejeon (KR); Yu Jin JUNG, Daejeon (KR); Sang-Ho LEE, Daejeon (KR); Hyocheol JUNG, Daejeon (KR)

(73) Assignee: KOREA RESEARCH INSTITUTE OF CHEMICAL TECHNOLOGY, Daejeon (KR)

(21) Appl. No.: 19/117,679

(22) PCT Filed: Sep. 15, 2023
(86) PCT No.: PCT/KR2023/013939

§ 371 Date: Apr. 2, 2025

(30) Foreign Application Priority Data
Oct. 20, 2022 (KR) 10-2022-0135766

(51) Int. Cl. C08G 75/00; C08K 5/3462; G02B 1/04

(52) U.S. Cl. CPC C08G 75/00; C08K 5/3462; G02B 1/04

(57) ABSTRACT

The present invention relates to a self-healing polythiourethane polymerizable composition, a self-healing polythiourethane produced therefrom, and a self-healing optical material produced using the self-healing polythiourethane, and having excellent transparency and a high refractive index and Abbe number. When an optical material is produced using the self-healing polyurethane, surface scratches caused by the external environment can be easily restored by natural light such as sunlight. In addition, such advantages make it possible for the present invention to be widely used in optical lenses for precision equipment, optical lenses for image sensors for autonomous vehicles, optical lenses for radar sensors, camera lenses, and protective coatings for lenses, etc.

### TECHNICAL FIELD

The present invention relates to a self-healing polythiourethane polymerizable composition, a self-healing polythiourethane prepared therefrom, and a self-healing optical material which is prepared using a dynamic network of the polythiourethane and has excellent transparency and durability, a high refractive index, and a high Abbe number.

### BACKGROUND ART

It is essential for an optical material such as a lens to control an appropriate refractive index and an Abbe number, depending on the application field. In particular, since a lens material having a high refractive index may achieve similar performance to a conventional thick low-refractive index lens with a small thickness, it is being applied to various fields. For example, a high-refractive index lens is being used as an optical material which is used in an image sensor, an actuator, and a time of flight (ToF) sensor or precision equipment. In addition, as an example of the optical material, a polythiourethane may be mentioned, and the polythiourethane is known as a polymer material having a high refractive index due to a sulfur atom inside.

For a high-performance optical material, a material having a higher refractive index was intended to be developed, but as the refractive index of the material increases, there was a problem in that the Abbe number in conflict with the refractive index decreases, so that the color dispersion of the optical material increases.

In addition, since the optical material transmits and refracts light to adjust an image size, there is a fatal problem in that when scratches occur on the surface of the material, performance is rapidly deteriorated. In particular, the optical material such as a lens which is used in precision equipment is high priced and is difficult to be exchanged; since the lens of an image sensor or a LiDAR sensor of an autonomous vehicle sensor module is exposed to the external environment, it scratches easily; and the scratches occurring like this causes sensor malfunction or image distortion and a serious accident may occur by any possibility. Thus, scratches occurring on the surface of the optical material act as a big problem.

Meanwhile, self-healing refers to an ability to heal oneself from damage introduced from the outside and may be implemented through an extrinsic or intrinsic method. In general, an intrinsic method is preferred to an extrinsic method, since the intrinsic method allows design of a molecular structure flexibly considering the environmental conditions and the self-healing conditions of the polymer, and the self-healing properties may be repeatedly implemented. In particular, reversible dynamic covalent bonds which undergo an exchange reaction by a specific stimulus are used as the most universal and powerful intrinsic method. A polymer material including the dynamic covalent bonds as such show mechanical properties similar to a thermoplastic plastic, when it coexists with a catalyst under a high temperature condition, unlike a non-recyclable thermosetting plastic material, and defects such as scratches inside or on the surface may be self-healed, using the material.

Accordingly, there is an urgent need for research and development of an optical material which has excellent transparency, may control both a refractive index and an Abbe number, and simultaneously allows self-healing against scratches.

### DISCLOSURE

### Technical Problem

An object of the present invention is to provide a self-healing polythiourethane polymerizable composition.

Another object of the present invention is to provide a self-healing polythiourethane which may self-heal scratches on the surface by irradiating with a light source and has high visible light transmittance, surface hardness, refractive index, and Abbe number.

In addition, another object of the present invention is to provide a self-healing optical material which is prepared using the self-healing polythiourethane described above, allows self-healing by near infrared light, and has excellent transparency and durability, a high refractive index, and a high Abbe number.

### Technical Solution

In order to achieve the above objects, the present inventors continuously studied to develop an optical material which has excellent transparency, may easily control a refractive index and an Abbe number, and simultaneously allows self-healing against scratches on the surface, and as a result, found that a self-healing polythiourethane which has both a high refractive index and a high Abbe number, has excellent indentation hardness and transparency, and may self-heal scratches on local areas within a short time by irradiation with a light in a near infrared area may be prepared from a polythiourethane polymerizable composition which includes an isocyanate monomer; a polyfunctional thiol-based monomer; and difunctional monomer including at least one or more of a hydroxyl or thiol functional group; and a photothermal dye together, thereby completing the present invention. Furthermore, by properly adjusting the monomer composition of the polythiourethane polymerizable composition, the refractive index and the Abbe number of the self-healing polythiourethane may be easily controlled within a refractive index range of 1.55 or more and an Abbe number of 30 or more. Thus, a self-healing polythiourethane having appropriate physical properties depending on the use may be prepared.

In one general aspect, a self-healing polythiourethane polymerizable composition includes: (a) a monomer mixture including: an isocyanate monomer; a polyfunctional thiol-based monomer; and a difunctional monomer including at least one or more of a hydroxyl or thiol functional group, and (b) a photothermal dye.

According to an exemplary embodiment of the present invention, the self-healing polythiourethane prepared from the self-healing polythiourethane polymerizable composition may have a refractive index of 1.55 or more and an Abbe number of 30 or more.

According to an exemplary embodiment of the present invention, when the self-healing polythiourethane is irradiated with a light source, the photothermal dye acts photothermally to generate heat, and the self-healing polythiourethane may be self-healed through carbamate exchange by the generated heat.

According to an exemplary embodiment of the present invention, the light source may be near infrared light having a wavelength of 850 to 1500 nm.

According to an exemplary embodiment of the present invention, the isocyanate monomer may be an aromatic diisocyanate compound.

According to an exemplary embodiment of the present invention, the polyfunctional thiol-based monomer may contain 4 or more thiol functional groups.

According to an exemplary embodiment of the present invention, the polyfunctional thiol-based monomer may be included at 10 to 200 parts by weight with respect to 100 parts by weight of the isocyanate monomer.

According to an exemplary embodiment of the present invention, the difunctional monomer may be any one or a combination of two or more selected from C₃₋₂₀ aliphatic dithiol or diol compounds and C₆₋₅₀ aromatic dithiol or diol compounds.

According to an exemplary embodiment of the present invention, the difunctional monomer may contain a disulfide (*—S—S—*), diselenium (*—Se—Se—*) or ditellurium (*—Te—Te—*) structure in the molecule.

According to an exemplary embodiment of the present invention, the difunctional monomer may be represented by the following structure:

FG₁-L₁-M-L₂-FG₂ [Structure]

wherein

FG₁ and FG₂ are independently of each other —OH or —SH, L₁ and L₂ are independently of each other any one or more selected from substituted or unsubstituted C₁₋₂₀ alkylene, C₁₋₂₀ heteroalkylene, C₆₋₃₀ cycloalkylene, C₆₋₃₀ arylene, and C₆₋₃₀ heteroarylene, and M is a direct bond, —S—S—, —Se—Se— or —Te—Te—.

According to an exemplary embodiment of the present invention, the difunctional monomer may be included at 1 to 100 parts by weight with respect to 100 parts by weight of the isocyanate monomer.

According to an exemplary embodiment of the present invention, the photothermal dye may be a diimmonium-based compound represented by the following Chemical Formula 1:

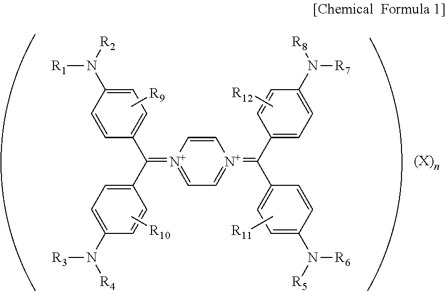

wherein
R₁ to R₁₂ are independently of one another hydrogen, halogen, substituted or unsubstituted C₁₋₁₆ alkyl, or substituted or unsubstituted C₆₋₁₆ aryl, X is an organic acid anion or an inorganic acid anion, and n is 1 or 2.

According to an exemplary embodiment of the present invention, in Chemical Formula 1, X is

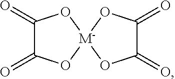

### M is B, and n is 2.

According to an exemplary embodiment of the present invention, the photothermal dye may be included at 0.01 to 1 part by weight with respect to 100 parts by weight of the monomer mixture.

According to an exemplary embodiment of the present invention, the isocyanate functional group of the isocyanate monomer to the sum of the thiol functional group of the polyfunctional thiol-based monomer and the hydroxyl and thiol functional groups of the difunctional monomer may satisfy an equivalent ratio of 1:1 to 2.

According to an exemplary embodiment of the present invention, the self-healing polythiourethane may have a glass transition temperature (To) of 70 to 110 °C.

According to an exemplary embodiment of the present invention, the self-healing polythiourethane may have a transmittance average in a visible light region of 350 to 780 nm of 80% or more, in the thickness conditions of 80±2 μm.

In another general aspect, a self-healing polythiourethane prepared from the self-healing polythiourethane polymerizable composition is provided.

In still another general aspect, a self-healing optical material prepared using the self-healing polyurethane described above is provided.

According to an exemplary embodiment of the present invention, the self-healing optical material may be for lenses or protective coatings for lenses.

### Advantageous Effects

Since the self-healing polythiourethane polymerizable composition according to the present invention includes a monomer having a specific structure, a self-healing polythiourethane prepared using the composition shows a high refractive index and a high Abbe number, has excellent indentation hardness and visible light transmittance, and when it is irradiated with light in a near infrared area based on a dynamic network, it may self-heal scratches in local areas within a short time. When an optical material is prepared by the self-healing polythiourethane, scratches on the surface by an external environment may be easily repaired by natural light such as sunlight. In addition, it may be widely used for optical lenses for precision equipment, optical lenses for image sensors for autonomous vehicles, optical lenses for radar sensors, protective coatings for lenses, and the like, using the advantages.

### DESCRIPTION OF DRAWINGS

FIG. 1 is a self-healing schematic diagram of self-healing polythiourethane according to an exemplary embodiment of the present invention.

FIG. 2 is a graph showing refractive indexes and Abbe numbers of Examples 1 to 9 and Comparative Example 1 of the present invention.

FIG. 3 is an image of polythiourethane films manufactured from the polythiourethane polymerizable compositions of Examples 7, 13, and 14 and Comparative Example 3 of the present invention.

FIG. 4 is a graph of transmittance measurement in an area of 350 to 2500 nm of the polythiourethane films manufactured from the polythiourethane polymerizable compositions of Examples 7, 13, and 14 and Comparative Example 3 of the present invention.

FIG. 5 is a graph showing a WSHE value depending on the load of the polythiourethane films manufactured from the polythiourethane polymerizable compositions of Examples 1 to 9 and Comparative Examples 1 to 3 of the present invention.

FIG. 6 is a graph of surface temperature change depending on an NIR laser irradiation time of the polythiourethane film manufactured from the polythiourethane polymerizable compositions of Examples 7, 13, and 14 and Comparative Example 3 of the present invention.

FIG. 7 is a 3D depth profile in which the polythiourethane films manufactured from the polythiourethane polymerizable compositions of Example 7 and Comparative Example 3 of the present invention were analyzed with a confocal microscope depending on self-healing time.

FIG. 8 is an optical microscope image by the load and the self-healing (irradiation with an NIR laser) time of the surface of the polythiourethane films manufactured from the polythiourethane polymerizable compositions of Example 7 and Comparative Example 3 of the present invention. A scale bar in the lower portion of the image is for estimating the width of scratches and corresponds to a length of 50 μm, and the scales of all images are the same.

FIG. 9 shows changes in diffraction phenomenon of an optical FT imaging system depending on the self-heating time of the polythiourethane films manufactured from the polythiourethane polymerizable compositions of Example 7 and Comparative Example 3 of the present invention.

FIG. 10 shows display glare changes depending on the self-healing time, using display cover windows including coating layers manufactured from the polythiourethane polymerizable compositions of Example 7 and Comparative Example 3 of the present invention.

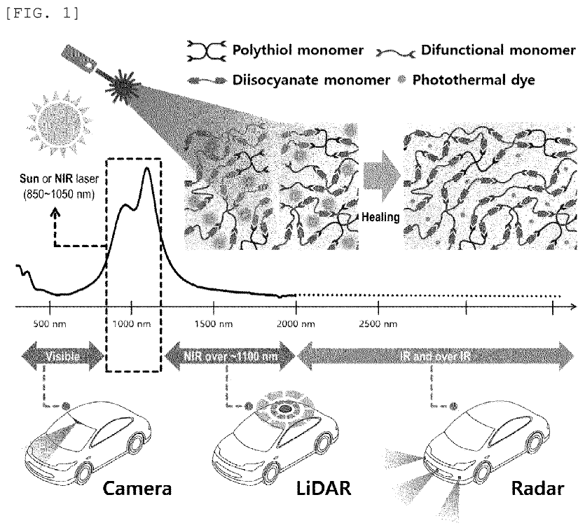

### BEST MODE

Hereinafter, the present invention will be described in more detail with reference to specific examples and exemplary embodiments including the accompanying drawings. However, the following exemplary embodiments are only a reference for describing the present invention in detail, and the present invention is not limited thereto, and may be implemented in various forms.

In addition, unless otherwise defined, all technical terms and scientific terms have the same meanings as those commonly understood by one of those skilled in the art to which the present invention pertains. The terms used herein are only for effectively describing a certain exemplary embodiment and not intended to limit the present invention.

In the present invention, unless explicitly described to the contrary, “comprising” any elements will be understood to imply further inclusion of other elements rather than the exclusion of any other elements.

In addition, the singular form used in the specification and claims appended thereto may be intended to include a plural form also, unless otherwise indicated in the context.

Technical terms and scientific terms used in the present specification have the general meaning understood by those skilled in the art to which the present invention pertains unless otherwise defined, and a description for the known function and configuration obscuring the gist of the present invention will be omitted in the following description and the accompanying drawings.

In addition, units used in the present specification without particular mention are based on weights, and as an example, a unit of % or ratio refers to a wt % or a weight ratio and wt % refers to wt % of any one component in a total composition, unless otherwise defined.

In addition, the numerical range used in the present specification may include all values within the range including the lower limit and the upper limit, increments logically derived in a form and span in a defined range, all double limited values, and all possible combinations of the upper limit and the lower limit in the numerical range defined in different forms. Unless otherwise particularly defined in the present specification, values which may be outside a numerical range due to experimental error or rounding off of a value are also included in the defined numerical range.

In addition, the term “self-healing” of the present specification refers to, in a broad sense, an ability to heal (recover or restore) to its original state automatically and autonomously without any external interference with a damaged material, and in a narrow sense, recovery of damage by an external force to its original state to some extent.

In addition, the term “substituted” of the present specification means that a hydrogen atom of a substituted part (for example, alkyl) is replaced with a substituent. Unless otherwise stated regarding the substituent, hydroxy, halogen, nitro, cyano, amino, secondary amine, carboxyl, carboxylate salt, C₁₋₇ alkyl, C₁₋₇ alkenyl, C₁₋₇ haloalkyl, C₁₋₇ alkoxy, C₁₋₇ alkoxycarbonyl, and the like may be included as any substituent of the present invention.

In addition, the term “alkyl” in the present specification includes both linear (straight chain) and branched forms, and may have 1 to 30 carbon atoms, preferably 1 to 20 carbon atoms.

In addition, the term “heteroalkyl” of the present specification refers to a radical having two bonding sites derived from heteroalkyl, and “hetero-” means that carbon of the alkyl is substituted by one or more heteroatoms selected from N, C(═O), P, P(═O), S, S(═O)₂, and a Si atom.

In addition, the term “cycloalkyl” of the present specification refers to a nonaromatic monocyclic or polycyclic ring system having 3 to 10 carbon atoms, may be 3- to 10-membered ring, preferably 5- to 7-membered ring, and may have an unsaturated bond in the ring.

In addition, the term “aryl” of the present specification refers to a carbocyclic aromatic group containing 5- to 10-membered ring atoms. A representative example includes phenyl, tolyl, xylyl, naphthyl, tetrahydronaphthyl, anthracenyl, fluorenyl, indenyl, azulenyl, and the like, but is not limited thereto.

In addition, the term “heteroaryl” of the present specification is a 5- to 10-membered aromatic heterocycle containing at least one carbon atoms including a mono- and bicyclic ring system and having at least one heteroatom selected from the group consisting of nitrogen, oxygen, and sulfur.

“Alkylene”, “heteroalkyl”, “arylene”, and “heteroarylene” described in the present invention refer to a divalent organic radical derived by removal of one hydrogen from “alkyl”, “heteroalkyl”, “aryl”, and “heteroaryl”, respectively, and follow each definition of the alkyl, the heteroalkyl, the aryl, and the heteroaryl.

Hereinafter, a self-healing polythiourethane polymerizable composition and a self-healing polythiourethane according to an exemplary embodiment will be described in more detail.

Conventionally, in order to solve the problems of high-refractive index optical materials which cause big problems due to scratch occurrence, the present inventors synthesized a polythiourethane from a polymerizable composition including a monomer mixture of specific monomers combined and a photothermal dye, and found that the polythiourethane has excellent mechanical properties such as indentation strength to have excellent durability, has high visible light transmittance, Abbe number, and refractive index to have excellent optical properties, and simultaneously, may be self-healed simply by being irradiated with a light source having a specific wavelength even when scratches occurs on the surface, thereby completing the present invention. Furthermore, based on the superior advantages, the polythiourethane may be widely used in the fields requiring optical properties, durability, and self-healing properties, as an example, for optical materials of optical lenses for precision equipment, optical lenses for image sensors for autonomous vehicles, optical lenses for radar sensors, camera lenses, and protective coatings of lenses.

The present invention provides a self-healing polythiourethane polymerizable composition including: (a) a monomer mixture including: an isocyanate monomer; a polyfunctional thiol-based monomer; and a difunctional monomer including at least one or more of a hydroxyl or thiol functional group, and (b) a photothermal dye.

According to an exemplary embodiment, the monomer mixture may include an isocyanate monomer, a polyfunctional thiol-based monomer, and a difunctional monomer, and the polythiourethane according to an exemplary embodiment may be synthesized from the monomer mixture.

According to an exemplary embodiment, as the isocyanate monomer, any one or a mixture of two or more selected from alicyclic isocyanate, aliphatic isocyanate, and aromatic isocyanate may be used, and the isocyanate monomer may be used without being largely limited as long as it is a monomer containing two or more isocyanate functional groups. In addition, the isocyanate monomer may have a molecular weight of 10 to 2,000 g/mol, specifically 10 to 1,000 g/mol, more specifically 50 to 700 g/mol, or 100 to 400 g/mol, but is not limited thereto as long as the physical properties to be desired in the present are not impaired.

Specifically, the isocyanate monomer may be, as a non-limiting example, one or a combination of two or more selected from methylene diphenyl diisocyanate (MDI), 4,4′-dicyclohexylmethane diisocyanate (H₁₂-MDI), toluene diisocyanate (TDI), xylene diisocyanate (XDI), methyl cyclohexylene diisocyanate (H₁₂-TDI), tetramethylxylene diisocyanate (TMXDI), hexamethylene diisocyanate (HDI), cyclohexylene diisocyanate, isophorone diisocyanate (IPDI), and the like, and preferably, may be an aromatic diisocyanate compound such as methylenediphenyl diisocyanate (MDI), toluene diisocyanate (TDI), and xylene diisocyanate (XDI), but may be used without being largely limited as long as it is a compound containing two or more isocyanate functional groups.

According to an exemplary embodiment of the present invention, the polyfunctional thiol-based monomer may contain 3 or more, specifically 4 or more thiol functional groups. The polyfunctional thiol-based monomer may act as a crosslinking agent and may be used without being largely limited as long as it is commonly used in polythiourethane and is a thiol-based monomer containing 3 or more thiol functional groups.

Specifically, the polyfunctional thiol-based monomer may be, as a non-limiting example, one or a combination of two or more selected from trimethylolpropanetris(2-mercaptoacetate), trimethylolethanetris(mercaptopropionate), trimethylolpropanetris(3-mercaptopropionate), pentaerythritoltetrakis(2-mercaptoacetate), bispentaerythritol-ether-h hexakis (mercaptopropionate) bispentaerythritol-ether-hexakis (2-mercaptoacetate), bispentaerythritolhexa (2-mercaptoacetate), bistrimethylolpropanetetrakis(3-mercaptopropionate), bistrimethylolpropanetetrakis(2-mercaptoacetate) (BTMPMA), and pentaerythritol tetrakis(3-mercaptopropionate) (PETMP), and the like.

According to an exemplary embodiment of the present invention, the polyfunctional thiol-based monomer may have a molecular weight of 10 to 2,000 g/mol, specifically 100 to 1,500 g/mol, and more specifically 200 to 700 g/mol, but is not limited thereto as long as the physical properties to be desired in the present invention are not impaired.

According to an exemplary embodiment of the present invention, the polyfunctional thiol-based monomer may be included at 10 to 200 parts by weight, specifically 40 to 150 parts by weight, and more specifically 100 to 120 parts by weight with respect to 100 parts by weight of the isocyanate monomer. When the range is satisfied, a polythiourethane having excellent mechanical properties such as indentation hardness and excellent optical properties and self-healing efficiency may be prepared.

In addition, the number of thiol functional groups of the polyfunctional thiol-based monomer may be included at 30 to 70%, preferably 40 to 60% (equivalent %) with respect to the total number included in the total monomer mixture but is not limited thereto.

According to an exemplary embodiment of the present invention, the difunctional monomer including at least one or more hydroxyl or thiol functional groups (hereinafter, difunctional monomer) may be a monomer containing two hydroxyl functional groups, two thiol functional groups, or one hydroxyl and one thiol functional group. Specifically, the difunctional monomer may be any one or a combination of two or more selected from C₃₋₂₀ aliphatic dithiol, C₃₋₂₀ aliphatic diol compounds, C₆₋₅₀ aromatic dithiol, and C₆₋₅₀ aromatic diol compounds, and the like. Preferably, in order to achieve the physical properties to be desired in the present invention, two or more difunctional monomers may be included, but is not limited thereto.

According to an exemplary embodiment of the present invention, the difunctional monomer may have a molecular weight of 10 to 2,000 g/mol, specifically 50 to 1,000 g/mol, and more specifically 100 to 500 g/mol, but is not limited thereto as long as the physical properties to be desired in the present invention are not impaired.

According to another exemplary embodiment of the present invention, the difunctional monomer may contain a disulfide (*—S—S—*), diselenium (*—Se—Se—*) or ditellurium (*—Te—Te—*) structure in the molecule. Preferably, it may be any one or a combination of two or more selected from a C₃₋₂₀ aliphatic dithiol or diol compound containing a disulfide (*—S—S—*) structure in the molecule, a C₆₋₅₀ aromatic dithiol or diol compound containing a disulfide (*—S—S—*) structure in the molecule, and a C₃₋₂₀ aliphatic dithiol or diol compound containing a diselenium (*—Se—Se—*) structure in the molecule, and the like.

According to another exemplary embodiment of the present invention, the difunctional monomer may be represented by the following structure:

FG₁-L₁-M-L₂-FG₂ [Structure]

wherein

FG₁ and FG₂ are independently of each other —OH or —SH, L₁ and L₂ are independently of each other any one or more selected from substituted or unsubstituted C₁₋₂₀ alkylene, C₁₋₂₀ heteroalkylene, C₆₋₃₀ cycloalkylene, C₆₋₃₀ arylene, and C₆₋₃₀ heteroarylene, and M is a direct bond, —S—S—, —Se—Se— or —Te—Te—.

Specifically, the structure may be any one or a combination of two or more selected from the compounds represented by the following Chemical Formulae 2 to 4:

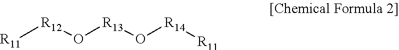

wherein R₁₁ is —OH or —SH, R₁₂ to R₁₄ are independently of one another substituted or unsubstituted C₁₋₂₀ alkylene, C₁₋₂₀ heteroalkylene, C₆₋₃₀ cycloalkylene, C₆₋₃₀ arylene, and C₆₋₃₀ heteroarylene. Specifically, R₁₁ may be —SH, and R₁₂ to R₁₄ may be independently of one another substituted or unsubstituted C₁₋₂₀ alkylene. More specifically, the C₁₋₂₀ alkylene may be any one or more selected from methylene, ethylene, propylene, butylene, pentylene, hexylene, heptylene, octylene, nonylene, decylene, and the like.

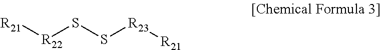

wherein R₂₁ is —OH or —SH, R₂₂ to R₂₃ are independently of each other any one or more selected from substituted or unsubstituted C₆₋₃₀ cycloalkylene, C₆₋₃₀ arylene, and C₆₋₃₀ heteroarylene. Specifically, R₂₁ may be —OH, and R₂₂ and R₂₃ may be substituted or unsubstituted phenylene.

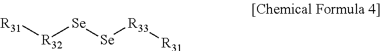

wherein R₃₁ is —OH or —SH, and R₃₂ and R₃₃ are independently of each other any one or more selected from substituted or unsubstituted C₁₋₂₀ alkylene, C₁₋₂₀ heteroalkylene, C₆₋₃₀ cycloalkylene, C₆₋₃₀ arylene, and C₆₋₃₀ heteroarylene. Specifically, R₃₁ may be —OH, and R₃₂ and R₃₃ of each other substituted or may be independently unsubstituted C₁₋₂₀ alkylene. Since the specific example of the C₁₋₂₀ alkylene is as described for Chemical Formula 3, it will be omitted.

According to an exemplary embodiment of the present invention, the difunctional monomer may be included at 1 to 100 parts by weight, specifically 1 to 100 parts by weight, and more specifically 1 to 100 parts by weight with respect to 100 parts by weight of the isocyanate monomer.

According to another exemplary embodiment of the present invention, the difunctional monomer may be a mixture of the compound represented by Chemical Formula 2 and the compound represented by Chemical formula 3: Herein, the compound represented by Chemical Formula 2 to the compound represented by Chemical Formula 3 may satisfy a weight ratio of 0.01 to 10:1, specifically 0.05 to 3:1, and more specifically 0.1 to 1:1, and may satisfy an equivalent ratio of 0.01 to 10:1, specifically 0.1 to 5:1, and more specifically 0.1 to 3:1. When the range is satisfied, a polythiourethane having a high refractive index and a high Abbe number, excellent transparency, and excellent self-healing efficiency may be prepared.

According to an exemplary embodiment of the present invention, the isocyanate functional group of the isocyanate monomer to the sum of the thiol functional group of the polyfunctional thiol-based monomer and the hydroxyl and thiol functional groups of the difunctional monomer may satisfy an equivalent ratio of 1:0.5 to 2, specifically 1:0.7 to 1.5, and more specifically 1:0.9 to 1.2.

According to an exemplary embodiment of the present invention, the self-healing polythiourethane polymerizable composition may further include a polyol compound. The polyol compound is not largely limited as long as it is a commonly used polyol, but may be any one or a mixture of two or more selected from ether-based polyol compounds, ester-based polyol compounds, carbonate-based polyol compounds, and the like. Otherwise, the polyol compound may be diol or triol, and may be a mixture of the two. As a non-limiting example, the diol may be a secondary alcohol, polyester diol, and polyether diol. Specifically, it may include ethylene glycol, 1,2-propanediol, 1,3-propanediol, 1,3-butanediol, 1,4-butanediol, 1,4-butenediol, 1,4-butynediol, 1,5-pentanediol, neopentyl glycol, bis(hydroxymethyl)cyclohexane, 2-methyl-1,3-propanediol, methylpentanediol, diethylene glycol, triethylene glycol, tetraethylene glycol, polyethylene glycol, dipropylene glycol, polypropylene glycol, dibutylene glycol, polybutylene glycol, polytetrahydrofuran, polycarbonatediol, polycaprolactonediol, polytetramethyleneether glycol (PTMEG), and the like, but is not limited thereto, and the polyol compound may be easily selected and used in order to implement the physical properties to be desired such as mechanical properties, but is not limited thereto. In addition, the polyol compound may be included at 1 to 100 parts by weight with respect to 100 parts by weight of the isocyanate monomer.

According to an exemplary embodiment of the present invention, the self-healing polythiourethane polymerizable composition may not include a catalyst or further include a catalyst. The catalyst may be a tin-based catalyst or a non-tin-based catalyst. A non-limiting example of the tin-based catalyst may include SnCl₄, butyltin trichloride, dibutyltin oxide, DBTDL, dibutyltin bis(2-ethylhexanoate), and the like, and a non-limiting example of the non-tin-based catalyst may include manganese (III) acetylacetonate (Mn(acac)₃), cobalt (III) acetylacetonate (Co(acac)₃), aluminum acetylacetonate (Al(acac)₃), iron (III) acetylacetonate (Fe(acac)₃), zinc acetylacetonate (Zn(acac)₂), and the like, but is not limited thereto. In addition, the catalyst may be included at 0.01 to 10 parts by weight with respect to 100 parts by weight of the monomer mixture.

According to an exemplary embodiment of the present invention, any photothermal dye may be used without being largely limited as long as it is a compound which adsorbs a light source to release heat energy, and the type and the wavelength band of light source may be easily adjusted depending on the purpose to be applied. Specifically, the photothermal dye may absorb near infrared light, more preferably near infrared light in an 850 to 1500 nm wavelength band, preferably near infrared light in an 850 to 1050 nm wavelength band.

According to an exemplary embodiment of the present invention, it may be a diimmonium-based compound represented by the following Chemical Formula 1:

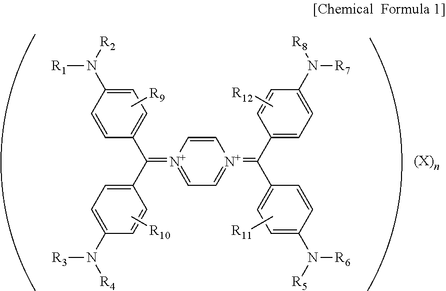

wherein
R₁ to R₁₂ are independently of one another hydrogen, halogen, substituted or unsubstituted C₁₋₁₆ alkyl, or substituted or unsubstituted C₆₋₁₆ aryl, X is an organic acid anion or an inorganic acid anion, and n is 1 or 2. Specifically, in Chemical Formula 1, X may be

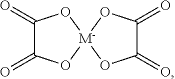

### may be B, and n may be 2.

As a non-limiting example, the organic acid anion may be an organic carboxylate ion, an organic sulfonate ion, an organic borate ion, and the like. The organic carboxylate ion may include an acetate ion, a lactate ion, a trifluoroacetate ion, a propionate ion, a benzoate ion, an oxalate ion, a succinate ion, or a stearate ion. In addition, the organic sulfonate ion may include a metal sulfonate ion, a toluene sulfonate ion, a naphthalene monosulfonate ion, a chlorobenzene sulfonate ion, a nitrobenzene sulfonate ion, a dodecylbenzene sulfonate ion, a benzene sulfonate ion, an ethane sulfonate ion, or a trifluoromethane sulfonate ion. The organic borate ion be, preferably, a may tetraphenylborate ion or a butyltriphenylborate ion.

As a non-limiting example, the inorganic acid anion may include a halogenite ion, for example, a fluoride ion, a chloride ion, a bromide ion, an iodide ion, a thiocyanate ion, a hexafluoroantimonate ion, a perchlorate ion, a periodate ion, a nitrate ion, a tetrafluoroborate ion, a hexafluorophosphate ion, a molybdate ion, a tungstate ion, a titanate ion, a vanadate ion, a phosphate ion, a borate ion, naphthalene-1,5-disulfonic acid, naphthalene-1,6-disulfonic acid, naphthalene disulfonic acid derivatives, and the like.

According to an exemplary embodiment of the present invention, the photothermal dye may be included at 0.01 to 1 part by weight, specifically 0.05 to 0.5 parts by weight, and more specifically 0.05 to 0.2 parts by weight with respect to 100 parts by weight of the monomer mixture. When the range is satisfied, optical properties such as transparency, refractive index and Abbe number are excellent and simultaneously excellent self-healing efficiency may be implemented.

The present invention may provide a self-healing polythiourethane prepared from the self-healing polythiourethane polymerizable composition. The self-healing polythiourethane polymerizable composition may be polymerized into a polythiourethane by a known method, and specifically, the self-healing polythiourethane polymerizable composition may be thermally cured in the presence of a catalyst, but the present invention is not limited thereto. In addition, the polythiourethane may contain a thiourethane bond in the molecule or contain both the thiourethane bond and a urethane bond.

According to an exemplary embodiment of the present invention, when the self-healing polythiourethane is irradiated with a light source, the photothermal dye acts photothermally to generate heat, and the self-healing polythiourethane may be self-healed through carbamate exchange by the generated heat.

When the self-healing process is described in more detail, a thermodynamic equilibrium state may be reversibly converted by an external stimulus such as temperature or catalyst, and for example, in the case of the polythiourethane, as the temperature rises to a glass transition temperature or higher, thiol or hydroxyl functional group which is newly formed by breakage (debonding) of a thiourethane bond; and an isocyanate functional group may form a urethane bond with other adjacent thiol or hydroxyl functional group or an isocyanate functional group, respectively, which to as is referred a carbamate dissociation exchange reaction. In addition, substituents connected to a crosslinking point may be exchanged while maintaining crosslinking density, which is referred to as a carbamate association exchange reaction, and in the present invention, the carbamate exchange reaction described above is used in order to implement the self-healing properties.

According to an exemplary embodiment of the present invention, since the self-healing polythiourethane includes the photothermal dye described above, it may absorb a light source in a wavelength band other than the range such as electromagnetic waves in the visible light region and NIR or IR region. Specifically, the light source may be near infrared light having a wavelength of 850 to 150 nm, specifically near infrared light having a wavelength band of 850 to 1050 nm, and with the properties, when the optical material manufactured the using self-healing polythiourethane is applied to an image sensor or LiDAR sensor which is recently mounted on an autonomous car, self-healing performance may be effectively implemented without interfering with the area such as electromagnetic waves in the visible light region and NIR or IR region, which is used by the image sensor or the LiDAR sensor.

According to an exemplary embodiment of the present invention, the self-healing polythiourethane may have a refractive index of 1.55 or more, specifically 1.58 to 2.0, and more specifically may have a high refractive index of 1.59 or more or 1.60 or more. In addition, the self-healing polythiourethane may have an Abbe number of 20 or more, specifically 30 or more, 31 or more, 32 or more, 33 or more, 34 or more, or 35 or more, and though the upper limit is not largely limited, it may be 60 or less or 50 or less. However, the refractive index and the Abbe number may be easily adjusted depending on the use to be applied. Furthermore, the self-healing polythiourethane to which the compound represented by Chemical Formula 4 is applied may complementarily improve both the refractive index and the Abbe number which is conventionally in conflict.

According to an exemplary embodiment of the present invention, the self-healing polythiourethane may have a glass transition temperature (T_{g}) of 70 to 110 °C, specifically 70 to 100 °C, and more specifically 70 to 90 °C. In addition, the self-healing polythiourethane may have a surface temperature which is increased to the glass transition temperature of the self-healing polythiourethane or higher, when it is irradiated with an NIR laser (1064 nm, 0.95 W) for 2 minutes at a thickness of 80 μm.

According to an exemplary embodiment of the present invention, the self-healing polythiourethane may have a thermal decomposition temperature (T_{d}) of 200 to 400 °C, specifically 210 to 300 °C, and more specifically 220 to 290 °C.

According to an exemplary embodiment of the present invention, the self-healing polythiourethane may have a transmittance average in the visible light region of 350 to 780 nm of 80% or more, specifically 80% to 99%, and more specifically 85% to 99% or 88% to 95%, under the thickness conditions of 80±2 μm.

According to an exemplary embodiment of the present invention, the self-healing polythiourethane may have an indentation hardness of 1 to 20 GPa, specifically 2 to 15 GPa, and more specifically 5 to 15 GPa, as measured in accordance the evaluation method of the present invention.

According to an exemplary embodiment of the present invention, the self-healing polythiourethane may have an indentation elastic modulus of 100 to 400 MPa, specifically 100 to 350 MPa, and more specifically 100 to 300 MPa, as measured in accordance with the evaluation method of the present invention.

According to an exemplary embodiment of the present invention, the self-healing polythiourethane may have a self-healing efficiency (WSHE) of 80% or more, specifically 90% or more, and more specifically 95% to 100%, as measured in accordance with the evaluation method of the present invention. In addition, the self-healing polythiourethane may be irradiated with an NIR laser (1064 nm, 0.95 W) for 30 seconds or more, 60 seconds or more, or 240 seconds or more, and as the time to irradiate the NIR laser for achieving the self-healing efficiency is shorter, the self-healing performance may be considered to be excellent. When the self-healing polythiourethane according to an exemplary embodiment is irradiated with the NIR laser for 240 seconds or less, preferably 120 seconds or less, and more preferably 60 seconds or less, the self-healing efficiency is satisfied and excellent self-healing performance may be shown.

The present invention may provide a self-healing optical material prepared using the self-healing polyurethane described above. Specifically, since the self-healing optical material has good mechanical properties such as indentation strength, it has excellent durability and high visible light transmittance, a high Abbe number, and a high refractive index to have excellent optical properties, and simultaneously, even with scratch occurrence on the surface, it may self-heal simply by irradiation with a light source having a specific wavelength. Based on the superior advantages, the optical material may be used for lenses such as optical lenses for precision equipment, optical lenses for image sensors for autonomous vehicles, optical lenses for radar sensors, camera lenses which require optical properties, durability, and self-healing properties, and scratches on the surface by an external environment may be easily repaired even by natural light such as sunlight.

Hereinafter, the present invention will be described in more detail with reference to the following examples. However, the following examples are only an example for describing the present invention in more detail, and do not limit the present invention in any way.

### [Method for Measuring Physical Properties]

1) Thermal decomposition temperature (T_{d}): the thermal decomposition temperature of the prepared self-healing polythiourethane was measured using thermogravimetric analysis (TA Instruments, TGA Q500), in a temperature range from room temperature to 700 °C at a heating rate of 10 °C/min under a nitrogen atmosphere, as the measurement conditions.

2) Glass transition temperature (T_{g}): the glass transition temperature of the prepared self-healing polythiourethane was measured using differential scanning analysis (DSC, TA instruments, DSC Q2000), in a temperature range of −40 to 80 °C at a heating rate of 10 °C/min under a nitrogen atmosphere.

3) Refractive index and Abbe number: the refractive index and the Abbe number of the prepared self-healing polythiourethane were measured using an Abbe refractometer (DR-M4) at 20 °C.

4) Visible light transmittance: a transmittance in a range of 350 to 2500 nm was analyzed using a spectrophotometer (JASCO V-770), and a transmittance average was calculated in a range of 350 to 780 nm which is a visible light region.

6) Indentation test: the indentation hardness (Hardness, H_{IT}) and the indentation elastic modulus (Modulus, E_{IT}) of the prepared self-healing polythiourethane were measured 3 times using an indentation hardness tester (Nanoindentation tester, Anton Paar, NHT³, Berkovich tip), and the average value is shown in the following Table 3. The measurement conditions were reaching each strength (5 mN, 10 mN, 25 mN, and 50 mN) at a speed of 20 mN/min and then maintaining for 10 seconds.

### [Preparation Example 1] Preparation of Photothermal Dye

0.22 g (0.24 mmol) of tris(dibenzylideneacetone) dipalladium (0), 0.09 ml (0.37 mmol) of tri-tert-butylphosphine, and 20 ml of anhydrous toluene were added to a 100 ml 2-neck round bottom flask, stirring was performed for 10 minutes under a nitrogen atmosphere to induce ligand exchange, 2.37 g (9.24 mmol) of 4-bromo-N, N-dibutylaniline was added to the flask, and stirring was performed for 10 minutes. Subsequently, 0.20 g (1.85 mmol) of p-phenylenediamine and 2.08 g (21.6 mmol) of sodium tert-butoxide were added to the flask, stirring was performed at 110 °C for 15 hours, and then the temperature was cooled to room temperature. The reactant was purified by extraction with ethyl acetate, and residual water was removed from an organic layer using MgSO₄. The product was recrystallized at 0 °C for 1 hour from a mixed solvent of dimethylformamide and isopropyl alcohol (50:150) to obtain 1.1 g of a purified DID precursor in a bright brown powder form (Yield: 80%).

Subsequently, 0.2 g (0.22 mmol) of the DID precursor, 0.11 g (0.54 mmol) of lithium bis(oxalate) borate, 10 ml of dichloromethane, and 5 ml of ethanol were added to a 2-neck flask, and reflux was performed for 2 hours. After 2 hours, when the reactant inside the flask turned dark green, 0.09 g (0.33 mmol) of potassium persulfate and 4 ml of water were added, refluxing was performed for 2 hours, a large amount of water and dichloromethane were added to terminate the reaction, and the product was washed with water several times to remove unreacted materials and impurities. The combined organic layer was distilled under vacuum to finally obtain 0.23 g of N-butyl-substituted diimmonium borate dye (DID) in a black solid form having the following structure (DID structure) (yield: 82%).

Analysis data of DID

¹H NMR (CDCl₃, 300 MHz): 6.90-6.57 (m, 20H), 3.29 (d, J=7.2 Hz, 16H), 1.57-1.55 (m, 16H), 1.38-1.36 (m, 16H), 0.95 (t, J=6.8 Hz, 24H).

¹³C NMR (CDCl₃, 75 MHz): 144.24, 142.41, 137.57, 125.33, 121.91, 113.61, 61.00, 26.46, 20.5.

HRMS (EI): calcd for C₆₂H₉₂N₆⁺ [M]⁺ 920.74; found, 920.74; calcd for C₆₂H₉₂N₆₂⁺ [M]²⁺ 460.37; found, 460.37; calcd for C₄BO₈⁻[M]⁻ 186.97; found, 186.97.

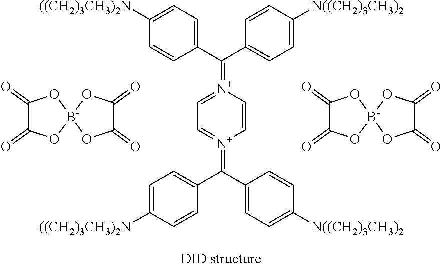

### [Preparation Example 2] Preparation of 2,2′-diselenobisethanol

First, 31.4 g of potassium hydroxide (KOH), 14 g of hydrazine hydrate, 30 ml of water, and 44.2 g of selenium powder were added to a 250 ml 3-neck flask equipped with a stirrer, a reflux cooler, and a thermometer, stirring was performed in a temperature range of 80 to 85 °C for 2 hours, and then the temperature was cooled to 40 °C Subsequently, 45.1 g of ethylene chlorohydrin was added to the flask, stirring was performed in a temperature range of 55 to 60 °C for 1 hour and 30 minutes, and then the temperature was cooled to 25 °C to terminate the reaction. An extract extracted in the process of adding the reactant to 60 ml of methylene chloride (MC) was dried with magnesium sulfate, the solvent was removed, the residue was distilled under vacuum to finally obtain 2,2′-diseleno bisethanol (DSDE).

### Example 1

2.44 g of pentaerythritol tetrakis(2-mercaptopropionate) (PETMP), 0.1 g of 3,6-dioxa-1,8-octanedithiol (DODT), and 1.99 g of xylene diisocyanate (XDI) to a 20 ml vial to prepare a monomer mixture. Subsequently, 0.1 parts by weight of the photothermal dye of Preparation Example 1 (N-butyl-substituted diimmonium borate dye, DID) was added to 100 parts by weight of the monomer mixture, and a solution in which 0.06 g of dibutyltin dilaurate as a catalyst was dissolved in 1 g of methyl ethyl ketone (MEK) was added to the monomer mixture to prepare the polymerizable composition according to Example 1.

### Example 2

The process was performed in the same manner as in Example 1, except that 0.4 g of DODT and 2.28 g of XDI were added.

### Example 3

The process was performed in the same manner as in Example 1, except that 0.6 g of DODT and 2.5 g of XDI were added.

### Example 4

The process was performed in the same manner as in Example 1, except that 0.14 g of dithiodiphenol (DTDP) without adding DODT.

### Example 5

The process was performed in the same manner as in Example 4, except that 0.54 g of DTDP and 2.28 g of XDI were added.

### Example 6

The process was performed in the same manner as in Example 4, except that 1.25 g of DTDP and 2.82 g of XDI were added.

### Example 7

The process was performed in the same manner as in Example 1, except that 0.58 g of DODT and 2.63 g of XDI were added, and additionally, 0.2 g of dithiodiphenol (DTDP) was further added to the monomer mixture.

### Example 8

The process was performed in the same manner as in Example 7, except that 0.36 g of DODT, 0.5 g of DTDP, and 2.63 g of XDI were added.

### Example 9

The process was performed in the same manner as in Example 7, except that 0.15 g of DODT, 0.8 g of DTDP, and 2.63 g of XDI were added.

### Example 10

The process was performed in the same manner as in Example 1, except that 0.14 g of 2,2′-diselenobisethanol (DSDE) of Preparation Example 2 was added without adding DODT.

### Example 11

The process was performed in the same manner as in Example 10, except that 0.53 g of DSDE and 2.28 g of XDI were added.

### Example 12

The process was performed in the same manner as in Example 10, except that 1.24 g of DSDE and 2.82 g of XDI were added.

### Example 13

The process was performed in the same manner as in Example 7, except that 0.05 parts by weight of the photothermal dye DID was added with respect to 100 parts by weight of the monomer mixture.

### Example 14

The process was performed in the same manner as in Example 7, except that 0.2 parts by weight of the photothermal dye DID was added with respect to 100 parts by weight of the monomer mixture.

### Comparative Example 1

The process was performed in the same manner as in Example 1, except that DODT, DTDP, DSDE, and the photothermal dye DID were not added and 1.88 g of XDI was added.

### Comparative Example 2

The process was performed in the same manner as in Comparative Example 1, except that 0.1 parts by weight of the photothermal dye DID was added with respect to 100 parts by weight of the monomer mixture.

### Comparative Example 3

The process was performed in the same manner as in Comparative Example 7, except that the photothermal dye was not added.

The mole composition ratio and the amount of DID added of the monomer mixtures of the examples and the comparative examples are shown in the following Table 1. Herein, the mole composition ratio is shown after calculating [(moles of added monomer)×(number of functional groups of the corresponding monomer)] of each monomer and then discarding the one's place of each ratio with the calculated value of the isocyanate compound (XDI) being 100.

TABLE 1

| | | | | | | Amount of DID added (with |
|---|---|---|---|---|---|---|
| | | | | | | respect to 100 parts by |
| | PETMP | DODT | DTDP | DSDE | XDI | weight of monomer mixture) |
| Example 1 | 90 | 10 | — | — | 100 | 0.1 parts by weight |
| Example 2 | 70 | 30 | — | — | 100 | 0.1 parts by weight |
| Example 3 | 50 | 50 | — | — | 100 | 0.1 parts by weight |
| Example 4 | 90 | — | 10 | — | 100 | 0.1 parts by weight |
| Example 5 | 70 | — | 30 | — | 100 | 0.1 parts by weight |
| Example 6 | 50 | — | 50 | — | 100 | 0.1 parts by weight |
| Example 7 | 50 | 40 | 10 | — | 100 | 0.1 parts by weight |
| Example 8 | 50 | 25 | 25 | — | 100 | 0.1 parts by weight |
| Example 9 | 50 | 10 | 40 | — | 100 | 0.1 parts by weight |
| Example 10 | 90 | — | — | 10 | 100 | 0.1 parts by weight |
| Example 11 | 70 | — | — | 30 | 100 | 0.1 parts by weight |
| Example 12 | 50 | — | — | 50 | 100 | 0.1 parts by weight |
| Example 13 | 50 | 40 | 10 | — | 100 | 0.05 parts by weight |
| Example 14 | 50 | 40 | 10 | — | 100 | 0.2 parts by weight |
| Comparative | 100 | — | — | — | 100 | — |
| Example 1 | | | | | | |
| Comparative | 100 | — | — | — | 100 | 0.1 parts by weight |
| Example 2 | | | | | | |
| Comparative | 50 | 40 | 10 | — | 100 | — |
| Example 3 | | | | | | |

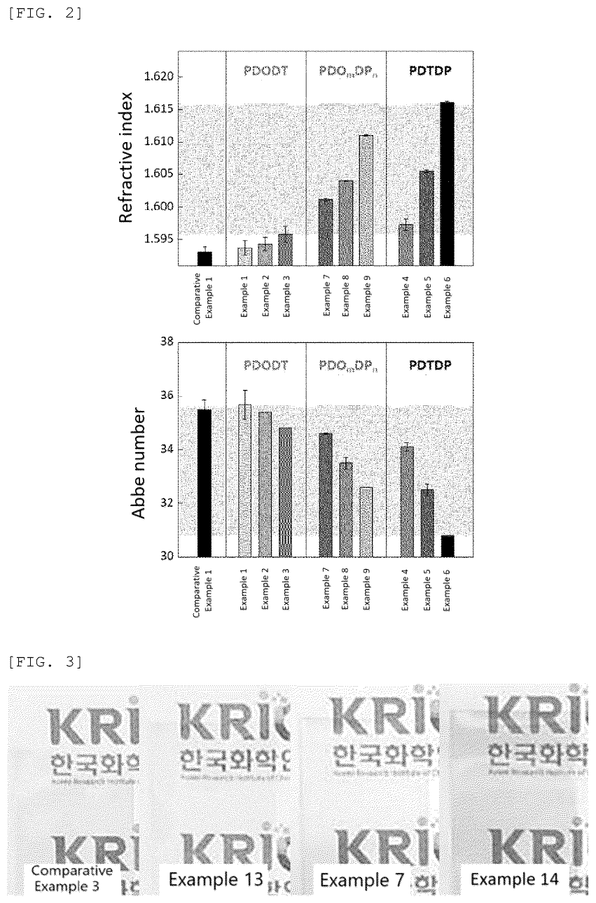

The surface of a slide glass was coated with the prepared polymerizable compositions of the examples and the comparative examples using a 96 μm bar coater, MEK was evaporated at room temperature for about 2 hours, and curing was performed in an oven at 80 °C for 2 hours to manufacture polythiourethane films of about 80 μm. The physical properties of the manufactured polythiourethane films were measured and are shown in the following Table 2. A graph for the refractive index and the Abbe number of the polythiourethane films manufactured from the self-healing polythiourethane polymerizable compositions of Comparative Example 1 and Examples 1 to 9 are shown in FIG. 2.

TABLE 2

| | | | | | Visible light |
|---|---|---|---|---|---|
| Polymerizable | | | Refractive | Abbe | transmittance |
| composition | Td [°C] | Tg [°C] | index | number | [%] |
| Example 1 | 290 | 86.8 | 1.594 | 35.7 | 96.9 |
| Example 2 | 276 | 80.0 | 1.594 | 35.4 | 95.8 |
| Example 3 | 260 | 72.1 | 1.596 | 34.8 | 96.9 |
| Example 4 | 243 | 86.2 | 1.597 | 34.1 | 90.6 |
| Example 5 | 225 | 88.4 | 1.605 | 32.5 | 88.0. |
| Example 6 | 219 | 89.7 | 1.616 | 30.8 | 85.9 |
| Example 7 | 230 | 72.8 | 1.601 | 34.6 | 94.3 |
| Example 8 | 222 | 78.8 | 1.604 | 33.5 | 92.6 |
| Example 9 | 223 | 83.0 | 1.611 | 32.6 | 89.8 |
| Example 10 | 255 | 82.1 | 1.597 | 45.2 | 88.1 |
| Example 11 | 238 | 78.8 | 1.603 | 48.0 | 84.0 |
| Example 12 | 278 | 80.5 | 1.612 | 50.0 | 78.0 |
| Example 13 | 280 | 82.8 | 1.601 | 34.6 | 95.0 |
| Example 14 | 285 | 85.0 | 1.601 | 34.6 | 86.1 |
| Comparative | 285 | 93.8 | 1.593 | 35.5 | 99.1 |
| Example 1 | | | | | |
| Comparative | 286 | 94.0 | 1.594 | 36.0 | 97.0 |
| Example 2 | | | | | |
| Comparative | 230 | 72.7 | 1.601 | 34.6 | 98.2 |
| Example 3 | | | | | |

In addition, the indentation hardness (HIT, GPa) and the indentation elastic modulus (EIT, MPa) of the polythiourethane films manufactured from the polymerizable compositions according to Examples 3, 6, and 9 and Comparative Example 2 were measured and are shown in the following Table 3.

TABLE 3

| | Indentation elastic modulus | | | | Indentation hardness | | | |
|---|---|---|---|---|---|---|---|---|
| Polymerizable | (EIT, MPa) | | | | (HIT, GPa) | | | |
| composition | 5 mN | 10 mN | 25 mN | 50 mN | 5 mN | 10 mN | 25 mN | 50 mN |
| Example 3 | 221.22 | 246.55 | 266.25 | 254.25 | 5.36 | 6.55 | 8.04 | 10.55 |
| Example 6 | 245.15 | 259.86 | 256.22 | 250.38 | 5.11 | 5.36 | 7.06 | 8.56 |
| Example 9 | 215.73 | 235.10 | 219.20 | 209.40 | 4.97 | 5.46 | 6.73 | 7.98 |
| Comparative | 200.77 | 221.86 | 243.61 | 254.08 | 4.90 | 5.48 | 7.60 | 7.86 |
| Example 2 | | | | | | | | |

As seen in Tables 1 to 3, it was confirmed that as the content of PTEMP increased and the content of DTDP increased compared to DODT, Td and Tg of the polythiourethane were increased. In addition, it was confirmed that Examples 1 to 12 all had good Abbe numbers of 30 or more and simultaneously excellent refractive indexes of 1.55 or more. Specifically, the examples using DODT had an excellent Abbe number and the examples using DTDP showed a high refractive index of 1.60 or more. It was confirmed from the examples that two elements were simultaneously controlled by selective adjustment of the difunctional monomer.

In addition, all polythiourethane films showed the visible light transmittance showing transparency of the film of 85% or more, preferably 90% or more, and showed the indentation hardness and the elastic modulus which were equivalent to or improved as compared with the film of Comparative Example 2 having a high crosslinking degree, and thus, it was confirmed that the self-healing polythiourethane film according to an exemplary embodiment had excellent transparency and durability.

Additionally, the visible light transmittances [%] of the polythiourethane films manufactured in the same manner as in Examples 1 to 12 by using the same monomer mixtures as those of Examples 1 to 12, except that the photothermal dye (DID) was added in changed amounts of 0/0.05/0.1 (same as Examples 1 to 12)/0.2 parts by weight with respect to 100 parts by weight of each monomer mixture were measured and are shown in the following Table 4. For example, when the used monomer mixture was Example 1 and the amount of the photothermal dye added was 0.05 parts by weight, the polymerizable composition in which 0.05 parts by weight of the photothermal dye (DID) was added to the monomer mixture of Example 1 (except the photothermal dye) with respect to 100 parts by weight of the monomer mixture was prepared, and the polythiourethane film was manufactured in the same manner as described above.

TABLE 4
Visible light transmittance [%]

| Used | Amount of photothermal dye added | | | |
|---|---|---|---|---|
| monomer | 0 (parts by | 0.05 (parts | 0.1 (parts by | 0.2 (parts by |
| mixture | weight) | by weight) | weight) | weight) |
| Example 1 | 99.6 | 97.4 | 96.9 | 88.0 |
| Example 2 | 98.9 | 98.0 | 95.8 | 88.8 |
| Example 3 | 99.5 | 97.7 | 96.9 | 89.7 |
| Example 4 | 98.5 | 93.8 | 90.6 | 88.3 |
| Example 5 | 96.3 | 90.0 | 88.0. | 85.5 |
| Example 6 | 94.8 | 88.4 | 85.9 | 83.6 |
| Example 7 | 98.2 | 95.0 | 94.3 | 86.1 |
| Example 8 | 97.1 | 94.1 | 92.6 | 85.5 |
| Example 9 | 96.0 | 93.5 | 89.8 | 84.1 |
| Example 10 | 95.5 | 90.6 | 88.1 | 83.7 |
| Example 11 | 92.4. | 87.8 | 84.0 | 79.5 |
| Example 12 | 88.2 | 83.7 | 78.0 | 74.3 |

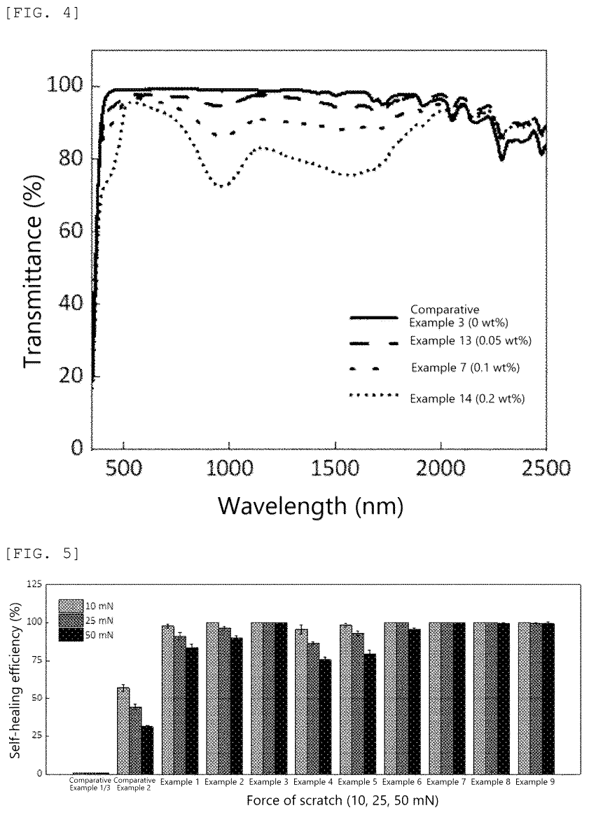

From Table 4, it was confirmed that the higher the content of the photothermal dye, the lower the transparency. In addition, the polythiourethane films manufactured from the polymerizable compositions of Example 7 (0.1 parts by weight), Example 13 (0.05 parts by weight), Example 14 (0.2 parts by weight), and Comparative Example 3 (0 parts by weight) in which only the content of the photothermal dye was changed in the same monomer mixture are shown in FIG. 3, and the transmittance graph of the film is shown in FIG. 4.

### [Evaluation of Self-Healing]

The surface of the polythiourethane films manufactured from the polymerizable compositions of Examples 1 to 9 and Comparative Examples 1 and 2 was scratched (with intervals of 10 nm on the coating surface at a speed of 4 mm/min with a constant load) with forces of 10, 25, and 50 mN, using a microscratch tester (Scratch-test machine (Anton Paar, Microscratch tester) with a Rockwell C indenter (tip radius: 10 μm)), and then was irradiated with an NIR laser (IR1064T3H-1000, Shanghai Laser & Optics Century Co., Ltd. (SLOC)) of 1064 nm at an intensity of 0.95 W for 2 minutes or 4 minutes (irradiation time) at a distance of 15 cm. Scratch thicknesses before and after NIR irradiation were observed and measured with an optical microscope, and are shown in FIG. 5. In addition, self-healing efficiency (width-based self-healing efficiency, WSHE) calculated by the following calculation formula is shown in the following Table 5.

$$WSHE = [ \frac{{R}_{w , s} - {R}_{w , h}}{{R}_{w , s}} ] \times 100 \qquad [ Calculation Formula ]$$

wherein R_{w,s} is the thickness of scratch before irradiation with an NIR laser, and R_{w,h} is the thickness of scratch after irradiation with an NIR laser.

TABLE 5
WSHE [%] (irradiation time: 4 minutes)

| | Force of scratch | | |
|---|---|---|---|
| | 10 mN | 25 mN | 50 mN |
| Example 1 | 98 | 91 | 83 |
| Example 2 | 100 | 96 | 90 |
| Example 3 | 100 | 100 | 100 |
| Example 4 | 95 | 86 | 76 |
| Example 5 | 98 | 93 | 79 |
| Example 6 | 100 | 100 | 95 |
| Example 7 | 100 | 100 | 100 |
| Example 8 | 100 | 100 | 99 |
| Example 9 | 100 | 100 | 99 |
| Comparative | 0 | 0 | 0 |
| Example 1 | | | |
| Comparative | 57 | 44 | 31 |
| Example 2 | | | |
| Comparative | 0 | 0 | 0 |
| Example 3 | | | |

As seen in Table 5, as the force increased, a scratch depth and a rupture degree on the surface of the film were increased, and when a scratch area of the polythiourethane film according to an exemplary embodiment was irradiated with an NIR laser for 4 minutes, the polythiourethane film repaired scratches on the surface of the film itself through self-healing, and showed a self-healing efficiency of 90% or more, preferably 95 to 100%. However, the optical film including no photothermal dye like Comparative Example 1 or 3 did not repair scratches, and Comparative Example 2 including only PETMP which is a tetrafunctional monomer showed a very poor self-healing efficiency of 60% or less.

In addition, when Examples 1 to 3 were compared, it was confirmed that as the content of DODT increased, the self-healing efficiency was improved, which was identically shown in Examples 4 to 6 to which DTDP was applied. It is expected due to the fact that as the content of PETMP which is a polyfunctional monomer decreases and the content of the difunctional monomer increases, a crosslinking degree is lowered and the flowability of molecular chains increases, so that the interchain exchange reaction of polythiourethane and urethane bonds occurs more easily.

In addition, the self-heating efficiency of Example 1 using DODT was higher than that of Example 4 using DTDP, and this is expected due to the fact that the polythiourethane of Example 1 including DODT having high chain flowability as compared with DTDP having a rigid benzene structure undergoes the interchain exchange reaction more easily, and Example 7 using both DODT and DTDP showed better self-healing efficiency than Examples 4 to 6.

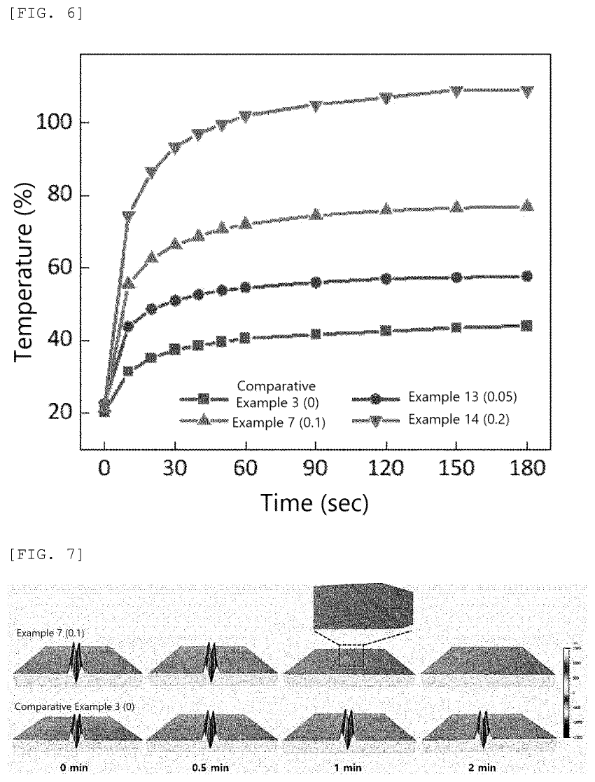

Additionally, when the polythiourethane films manufactured from the polymerizable compositions of Example 7 (0.1 parts by weight), Example 13 (0.05 parts by weight), Example 14 (0.2 parts by weight), and Comparative Example 3 (0 parts by weight) in which only the content of the photothermal dye was changed in the same monomer mixture were irradiated with an NIR laser for 3 minutes and the temperature of the film surface was measured using a thermal imaging camera (E8, FLIR), the temperature of the films of Examples 13, 7, and 14 was increased to 58 °C, 77 °C, and 110 °C, respectively, and the graph therefor is shown in FIG. 6. Thus, it was confirmed that the temperature increase degree of the film varied depending on the content of the photothermal dye, and it was found that in order to reach at least a temperature of 72.8 °C which is the glass transition temperature or higher so that self-healing was possible, the photothermal dye should be included at a content of at least 0.1 parts by weight or more.

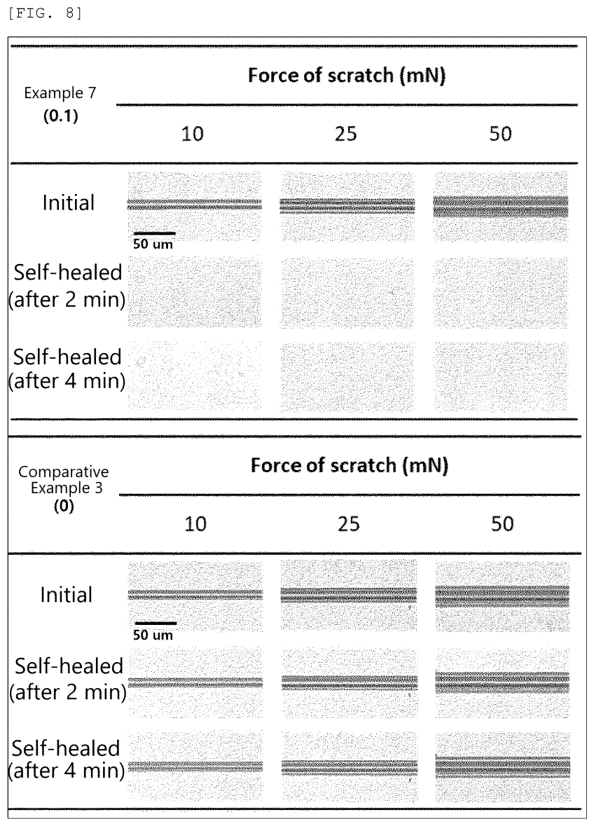

In addition, in the process of self-healing evaluation, a 3D depth profile depending on the time (0, 0.5, 1, 2 min.) of the films manufactured from Example 7 and Comparative Example 3 was analyzed with a confocal microscope (LSM 900, ZEISS), the image is shown in FIG. 7, and the optical microscope image of the surface of the films depending on the time (0, 1, and 2 min) is shown in FIG. 8. Referring to FIG. 7, it is confirmed that Example 7 including the photothermal dye self-healed the scratched part within 1 minute, and as in FIG. 8, scratch parts with various forces (10, 25, 50 nM) were self-healed within 2 minutes.

### [Evaluation of Optical Signal Distortion]

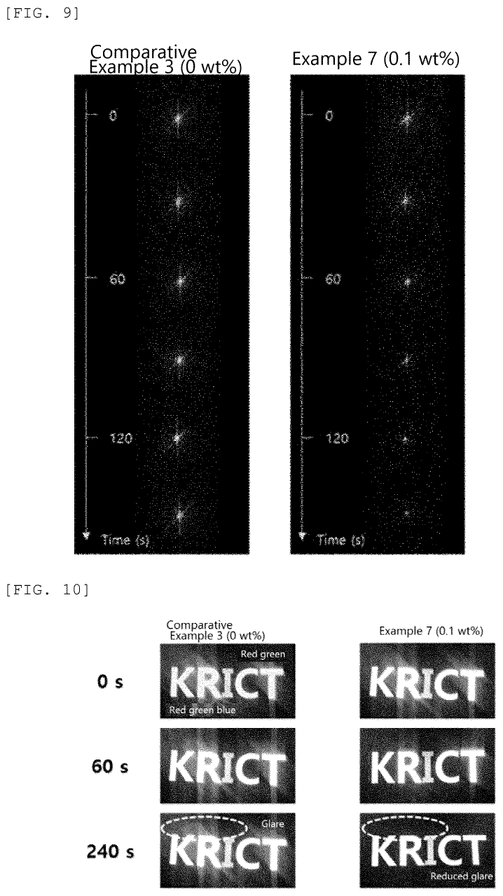

5 or more scratches were made on the surface of the polythiourethane films according Example 7 and Comparative Example 3 at an angle of 0° and −45°, and the films were placed in front of a Fourier transform laser light source of an optical Fourier-transform imaging system/light source: 532 nm-wavelength laser (Cobolt Samba© 1500, Cobolt AB) and irradiated with an NIR laser of 1064 nm from a distance of 15 cm for 150 seconds to perform self-healing. Changes in a diffraction phenomenon coming from the Fourier transformation laser light source were observed by irradiation with an NIR laser and are shown in FIG. 9. As shown in FIG. 9, 180° diffracted patterns were confirmed in all films at the scratched angle before irradiation with an NIR laser. However, Example 7 self-healed as it was irradiated with the NIR laser and had a gradually decreased diffraction phenomenon of the Fourier transformation laser light source, but the diffraction phenomenon was still observed in Comparative Example 3.

In addition, a glare test process of the polythiourethanes according to Example 7 and Comparative Example 3 is shown in FIG. 10. Specifically, a display cover window was coated with the polythiourethane polymerizable compositions according to Example 7 and Comparative Example 3 and cured to form coating layers, 5 or more scratches were made on the coating layers at angles of 0° and 45°, an image having red, green, and blue colors was displayed on a display in a dark environment, and irradiation with the NIR laser was performed to perform self-healing. As shown in FIG. 10, it was confirmed that the polythiourethane coating layer according to Example 7 showed a reduced glare phenomenon as the irradiation time passed, and the glare phenomenon disappeared after 240 seconds.

Thus, it was confirmed that the self-healing polythiourethane prepared from the self-healing polythiourethane polymerizable composition according to an exemplary embodiment has excellent self-healing efficiency, high visible light transmittance, a high Abbe number, a high refractive index, superior mechanical properties such as indentation strength, and superior thermal properties such as glass transition temperature and thermal decomposition temperature, and an optical material having excellent transparency, optical properties, durability, and self-healing properties may be prepared using the polythiourethane. Furthermore, the optical material may be widely used for optical lenses for precision equipment, optical lenses for image sensors for autonomous vehicles, optical lenses for radar sensors, protective coatings for lenses, and the like.

The present invention described above is only an example, and it may be well understood by a person with ordinary knowledge in the art to which the present invention pertains that various modification and equivalent other examples are possible therefrom. Therefore, it may be well understood that the present invention is not limited only to the form mentioned in the above detailed description. Accordingly, the true technical protection scope of the present invention must be determined by the spirit of the appended claims.

Therefore, the spirit of the present invention should not be limited to the above-described exemplary embodiments, and the following claims as well as all modifications equal or equivalent to the claims are intended to fall within the scope and spirit of the invention.

1. A self-healing polythiourethane polymerizable composition comprising:
(a) a monomer mixture comprising: an isocyanate monomer; a polyfunctional thiol-based monomer; and a difunctional monomer comprising at least one or more of a hydroxyl or thiol functional group, and
(b) a photothermal dye.

2. The self-healing polythiourethane polymerizable composition of claim 1, wherein a self-healing polythiourethane prepared from the self-healing polythiourethane polymerizable composition has a refractive index of 1.55 or more and an Abbe number of 30 or more.

3. The self-healing polythiourethane polymerizable composition of claim 2, wherein when the self-healing polythiourethane is irradiated with a light source, the photothermal dye acts photothermally to generate heat, and the self-healing polythiourethane is self-healed through carbamate exchange by the generated heat.

4. The self-healing polythiourethane polymerizable composition of claim 3, wherein the light source is near infrared light having a wavelength of 850 to 1500 nm.

5. The self-healing polythiourethane polymerizable composition of claim 1, wherein the isocyanate monomer is an aromatic diisocyanate compound.

6. The self-healing polythiourethane polymerizable composition of claim 1, wherein the polyfunctional thiol-based monomer contains 4 or more thiol functional groups.

7. The self-healing polythiourethane polymerizable composition of claim 1, wherein the polyfunctional thiol-based monomer is comprised at 10 to 200 parts by weight with respect to 100 parts by weight of the isocyanate monomer.

8. The self-healing polythiourethane polymerizable composition of claim 1, wherein the difunctional monomer is any one or a combination of two or more selected from C₃₋₂₀ aliphatic dithiol or diol compounds and C₆₋₅₀ aromatic dithiol or diol compounds.

9. The self-healing polythiourethane polymerizable composition of claim 8, wherein the difunctional monomer contains a disulfide (*—S—S—*), diselenium (*—Se—Se—*) or ditellurium (*—Te—Te—*) structure in the molecule.

10. The self-healing polythiourethane polymerizable composition of claim 1, wherein the difunctional monomer is represented by the following structure:
FG₁-L₁-M-L₂-FG₂ [Structure]
wherein
FG₁ and FG₂ are independently of each other —OH or —SH, L₁ and L₂ are independently of each other any one or more selected from substituted or unsubstituted C₁₋₂₀ alkylene, C₁₋₂₀ heteroalkylene, C₆₋₃₀ cycloalkylene, C₆₋₃₀ arylene, and C₆₋₃₀ heteroarylene, and M is a direct bond, —S—S—, —Se—Se— or —Te—Te—.

11. The self-healing polythiourethane polymerizable composition of claim 1, wherein the difunctional monomer is comprised at 1 to 100 parts by weight with respect to 100 parts by weight of the isocyanate monomer.

12. The self-healing polythiourethane polymerizable composition of claim 1, wherein the photothermal dye is a diimmonium-based compound represented by the following Chemical Formula 1: 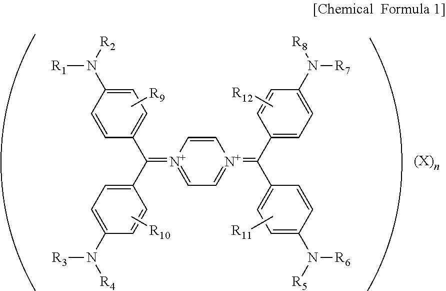
wherein
R₁ to R₁₂ are independently of one another hydrogen, halogen, substituted or unsubstituted C₁₋₁₆ alkyl, or substituted or unsubstituted C₆₋₁₆ aryl, X is an organic acid anion or an inorganic acid anion, and n is 1 or 2.

13. The self-healing polythiourethane polymerizable composition of claim 12, wherein in Chemical Formula 1, X is 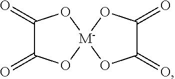
M is B, and nis 2.

14. The self-healing polythiourethane polymerizable composition of claim 1, wherein the photothermal dye is comprised at 0.01 to 1 part by weight with respect to 100 parts by weight of the monomer mixture.

15. The self-healing polythiourethane polymerizable composition of claim 1, wherein an isocyanate functional group of the isocyanate monomer to the sum of the thiol functional group of the polyfunctional thiol-based monomer and the hydroxyl and thiol functional groups of the difunctional monomer satisfies an equivalent ratio of 1:1 to 2.

16. The self-healing polythiourethane polymerizable composition of claim 2, wherein the self-healing polythiourethane has a glass transition temperature (T_{g}) of 70 to 110 °C.

17. The self-healing polythiourethane polymerizable composition of claim 2, wherein the self-healing polythiourethane has a transmittance average in a visible light region of 350 to 780 nm of 80% or more, in thickness conditions of 80±2 μm.

18. A self-healing polythiourethane prepared from the self-healing polythiourethane polymerizable composition of claim 1.

19. A self-healing optical material prepared using the self-healing polythiourethane of claim 18.

20. The self-healing optical material of claim 19, wherein the self-healing optical material is for lenses or protective coatings for lenses.
